(19) United States
(12) Patent Application Publication
(10) Pub. No.: US 2008/0084481 A1
(43) Pub. Date: Apr. 10, 2008

(54) CAMERA CONTROL INTERFACE

(75) Inventor: Richard Arthur LINDSAY, Suffolk (GB)

Correspondence Address: MCGUIREWOODS, LLP, 1750 TYSONS BLVD, SUITE 1800, MCLEAN, VA, 22102, US

(73) Assignee: THE VITEC GROUP PLC, Suffolk (GB)

(21) Appl. No.: 11/868,256

(22) Filed: Oct. 5, 2007

(30) Foreign Application Priority Data
Oct. 6, 2006 (GB) 0619850.1

(51) Int. Cl. H04N 5/232

(52) U.S. Cl. 348/211.7; 348/E05.042

(57) ABSTRACT

The disclosure relates to a camera control interface for a video camera having powered translation/rotation in multiple axes. The control system comprising a monitor for replicating the field of view of the camera, a manually operable controller for inputting translation/rotation commands in multiple axes and a processor for transmitting input commands to the controller to the camera. The processor provides a plurality of different sets of axes in which the camera may be required to move and means for selecting a set axis or axes from said plurality of sets for the camera to move in in response to controller commands.

### CROSS REFERENCE

This application claims foreign priority under 35 U.S.C. § 119 to United Kingdom Patent Application No. 0619850.1 filed on Oct. 6, 2006 the disclosure of which are expressly incorporated by reference herein in its entirety.

### BACKGROUND OF THE INVENTION

1. Field of the Invention

This invention relates to camera control interfaces for video/movie cameras.

2. Description of the Prior Art

In conventional manual camera operation, the cameraman directly interacts with the camera and environment through tactile and visual cues and feedback. In remote operation the controller needs to provide a man/machine interface that recreates or provides alternative closed loop control for the operator.

### SUMMARY OF THE INVENTION

An object of this invention is to provide an intuitive interface to remotely control camera movement in a multi degree of freedom environment in order to achieve desired dynamic creative effects in the image recorded by the camera.

This invention provides a camera control interface for a video camera having powered translation/rotation in multiple axes, the control system comprising a viewfinder for replicating the field of view of the camera, a manually operable controller for inputting translation/rotation commands in multiple axes and processor means for transmitting input commands to the controller to the camera, the processor means providing plurality of different sets of axes in which the camera may be required to move and means for selecting a set of axes or axes from more than one set for the camera to move in in response to controller commands.

In the above arrangement one or more selected axes may be locked out.

More specifically the axes provided by the processor may comprise global axes, related to the environment, local axes related to the camera, or user defined axes or any combination thereof.

Preferably a supplemental camera may be provided for creating a wider field of view than the first camera and the view finder is connected to both cameras to display the wider field of view from the supplemental camera and the specific field of view from the first mentioned camera within said wider field.

In any of the above arrangements the controller may comprise a six axis controller.

Thus, in accordance with the invention tactile control is provided via a multi degree of freedom input transducer (e.g. a Spacemouse) driving a multi degree of freedom camera mounting (e.g. a robotic arm) characterised in that the degrees of freedom of the mounting may be defined according to selectable co-ordinate axes that may be global (locked to environment), local (locked to camera) or user-defined (e.g. locked to a feature in the environment), or any combination thereof. Additionally, movement of the mounting may be constrained in or about any axis by selectively locking out any combination of its degrees of freedom.

Visual feedback is provided by a combination of the image recorded by the camera and one or more supplementary images showing the wider environment. Typically a supplementary image may be provided by an additional camera operating alongside and aligned with the working camera and having a wide-angle field of view. The field of view of the supplementary camera may be linked to that of the working camera or adjustable by the operator.

Alternatively or additionally a remotely located spotter camera may be mounted to provide a view of the working camera and its environment.

Working and supplementary images may be displayed separately or overlaid in a single display.

### BRIEF DESCRIPTION OF THE DRAWINGS

The following is a description of some specific embodiments, reference being made to the accompanying drawings in which:

FIG. 1 is a diagrammatic illustration of a two-part articulated arm mounted at one end on a base providing three orthogonal axes of movement and having a mounting for a camera at the other end providing three orthogonal axes of movement;

FIG. 2 is a similar perspective view of the camera mounting of FIG. 1 looking at the camera and mounting from a different direction;

FIGS. 3a, 3b and 3c show different combinations of camera motion axes assigned to the functional axes of the controller; and

FIG. 4 is a diagrammatic view of a control system for the camera mounting.

### DESCRIPTION OF THE PREFERRED EMBODIMENTS

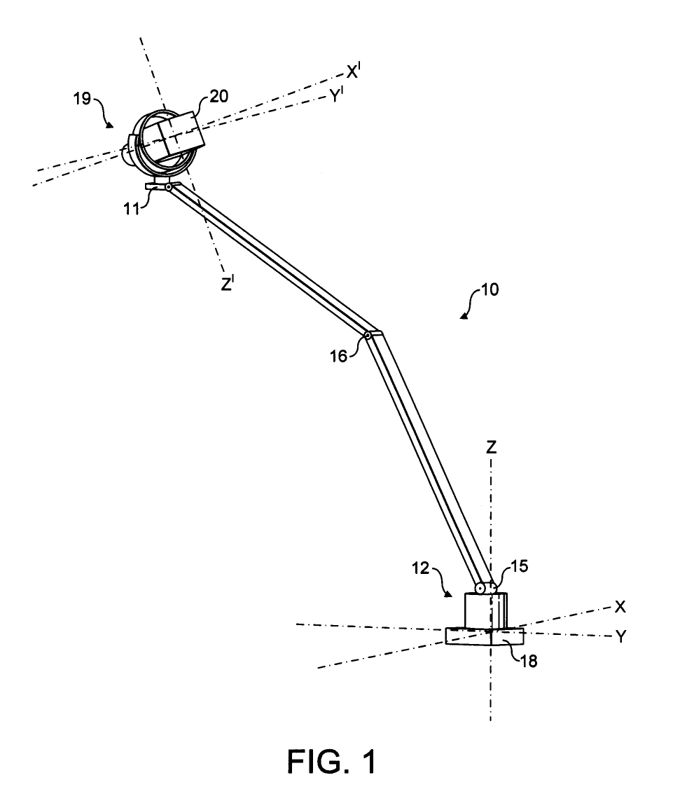

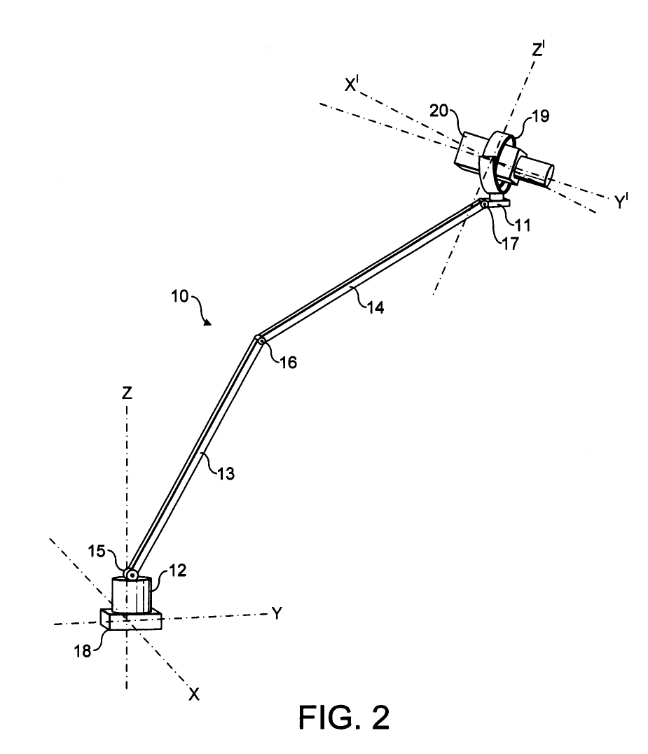

Referring firstly to FIGS. 1 and 2 of the drawings, there is shown an articulated arm indicated at 10 for imparting three-dimensional translation to a camera mounting indicated at 11. Arm 10 comprises a base indicated at 12, a lower link 13, an upper link 14 and the platform 11 which are joined in series for coplanar rotation by motorised hinges shown at 15, 16 and 17 respectively. The base 12 has a motorised connection to a floor mounted support 18 for rotation about a vertical axis. A three axis gimballed camera mount indicated at 19 is attached to platform 11 for imparting motorised pan, tilt and roll motions to a camera indicated at 20. In combination, arm 10 and camera mounting 19 provide full three-dimensional translation and rotation for the camera.

For each position of the arm and camera mounting shown, the principle axes of the global environment are indicated at XYZ and the local camera axes at X′Y′Z′.

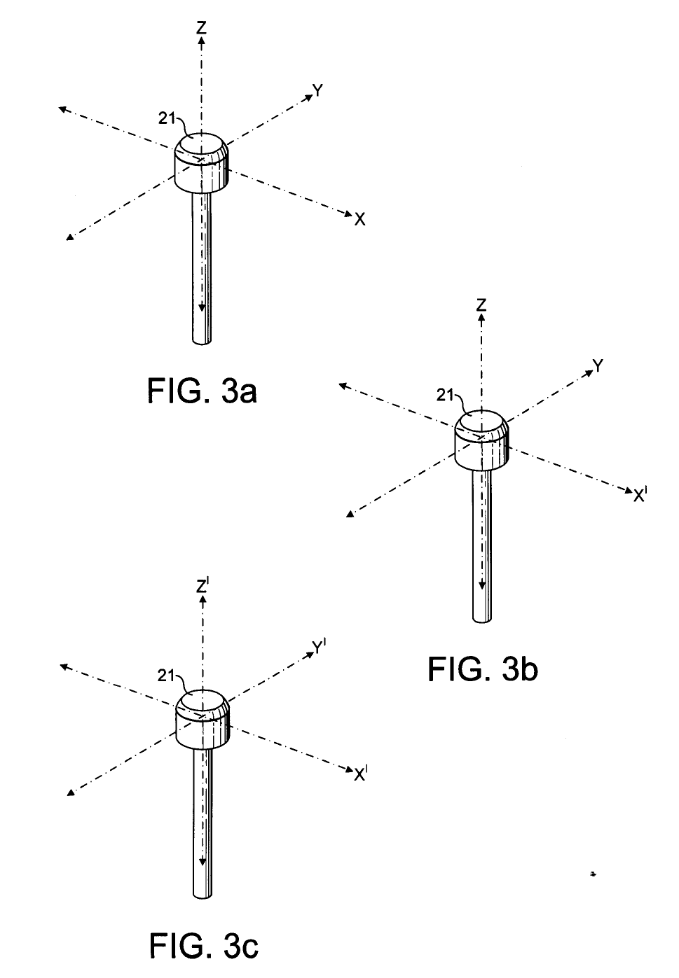

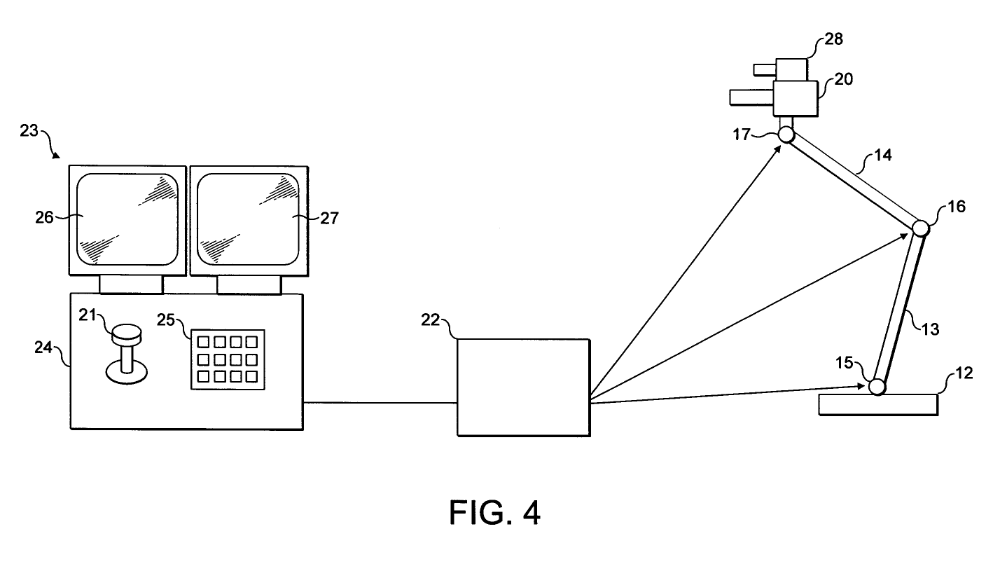

FIGS. 3a, 3b and 3c show examples of different combinations of axes which can be selectively assigned to a multi-axis controller 21 for movement of the camera by a control system which will now be described with reference to FIG. 4 of the drawings.

The various motorised units for the camera arm and supporting base for the arm are controlled by a microprocessor indicated at 22 which receives commands from a user interface indicated at 23. The user interface comprises a control panel 24 having a multi-axis controller 21 for inputting commands to the processor to move the camera in selected directions/orientations. The control panel also has a keypad 25 for specifying and assigning the relationship between controller axes and camera motion axes such as those illustrated in FIGS. 3a to 3c and the locking of non-elected axes to prevent movement as required.

The user interface has one viewfinder or screen 26 which shows the current scene as viewed by the camera and a supplementary viewfinder or screen 27 for showing the view seen by a spotter camera 28 which can be positioned adjacent the active camera or at a fixed location in relation to the active camera for showing the bigger scene part of which the principal camera is viewing. The spotter camera with its supplementary view as seen in the viewfinder 27 provides a wider view than the principal camera 20 and enables the operator to be aware of the environment outside the field of view of the principal camera.

Thus the arrangement provides a camera having multiple degrees of freedom on its mounting with selectable coordinate axes which may be global, that is locked to the environment, local, that is locked to the camera or user defined in relation to a feature in the environment or any combination thereof. Visual feedback of the camera operation is provided by the main viewfinder 35 augmented by the supplementary viewfinder 36 showing the view from the spotter camera.

1. A camera control interface for a video camera having powered translation/rotation in multiple axes, the control system comprising a monitor for replicating the field of view of the camera, a manually operable controller for inputting translation/rotation commands in multiple axes and processor means for transmitting input commands to the controller to the camera, the processor means providing a plurality of different sets of axes in which the camera may be required to move and means for selecting a set of axes or axes from more than one set for the camera to move in in response to controller commands.

2. A camera control interface as claimed in claim 1, wherein the control system also allows one or more axes to be locked out.

3. A camera control interface as claimed in claim 1, wherein the axes provided by the processor comprise global axes, related to the environment, local axes related to the camera or user defined axes or any combination thereof.

4. A camera control interface as claimed in claim 1, wherein a supplemental camera is provided for creating a wider field of view than the first camera and the monitor is connected to both cameras to display the wider field of view from the supplemental camera and the specific field of view from the first mentioned camera within said wider field or in separate monitors.

5. A camera control interface as claimed in claim 4, wherein the fields of view of the first and supplemental cameras are linked to zoom in and out together.

6. A camera control interface as claimed in claim 4, wherein the first and supplemental cameras are aligned along adjacent axes.

7. A camera control interface as claimed in claim 4, wherein a further supplemental camera is mounted remotely.

8. A camera control interface as claimed in claim 4, wherein the image of the supplemental camera includes an optical marker (e.g. cross hairs) to indicate the centre of the field of view of the first camera.

9. A camera control interface as claimed in any of the preceding claims, wherein the controller comprises a multi-axis remote controller.
